(19) United States
(12) Patent Application Publication
(10) Pub. No.: US 2005/0037794 A1
(43) Pub. Date: Feb. 17, 2005

(54) Communications feature for dispatch systems

(76) Inventors: Joseph C. Namm, Plantation, FL (US); Jeffrey R. Brigman, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/630,477

(22) Filed: Jul. 30, 2003

(51) Int. Cl. H04B 7/00

(52) U.S. Cl. 455/519; 455/508

(57) ABSTRACT

A communication system (100) includes a dispatch console (102) communicating with a plurality of subscriber units (104). Each subscriber unit (104) has a unit ID associated therewith. The dispatch console (102) automatically logs (206) the unit ID of each subscriber unit (104) that responds to an incident broadcast and forms a talkgroup (208) of the logged unit IDs for future incident broadcasts. Thus, the user can change talkgroups and/or channels without missing future incident broadcasts.

### TECHNICAL FIELD

This invention relates in general to two-way radios and more particularly to channel selector communication features associated with such radios.

### BACKGROUND

Dispatch communication systems are known to include a wireless infrastructure and a plurality of communication units, such as two-way radios and subscriber units. The basic operation and structure of a land mobile radio system is well known. Land mobile radio systems typically comprise one or more radio communication units and one or more repeaters that transceive information via radio frequency (RF) communication resources. These communication resources may be narrow band frequency modulated channels, time division multiplex slots, frequency pairs, and so forth. Land mobile radio systems may be organized as conventional communication systems, where the radios communicate directly possibly through a repeater acting as an amplifier, or trunked communication systems, where a plurality of communication resources is allocated amongst a group of users by assigning repeaters on a communication-by-communication basis within an RF coverage area.

Land mobile radio systems are useful for providing communications for many different types of users, including police agencies, radio departments, businesses with dispatch requirements such as ambulances and taxis, utilities, armed forces, trucking, and so forth. As an incident is attended to by users of the communication units, the status of the communication units associated with such users is communicated over a wireless communication channel from the communication units that are participating in the handling of the incident.

Typically, a dedicated incident channel is used to broadcast incident information amongst the users of a particular talkgroup. A revert channel feature may be used to facilitate the transfer of incident information amongst users within the group. The revert feature forces the two-way radio to revert to the dedicated incident channel when the user tries to send an incident message. However, this feature is limited to the single radio initiating the incident message. Furthermore, if the channel selector is bumped or inadvertently moved to another position, the radio is moved to a different talkgroup. Moving amongst different talkgroups may limit the ability of receiving updated incident information. Additionally, in a large response effort, smaller teams may move amongst different talkgroups and also miss information broadcast on the original talkgroup channel.

Accordingly, it would be desirable to have a means of improving the ability to receive broadcast incident information within a communications system.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a block diagram of a communications system operating in accordance with the present invention;

FIG. 2 is a method of broadcasting an incident alert in a communications system in accordance with the present invention; and

FIG. 3 is an example of utilizing the method of broadcasting an incident alert described n FIG. 2 utilizing two-way radios.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

In accordance with the present invention, there will be described herein a means for improving the ability to communicate incident alerts within a communication system.

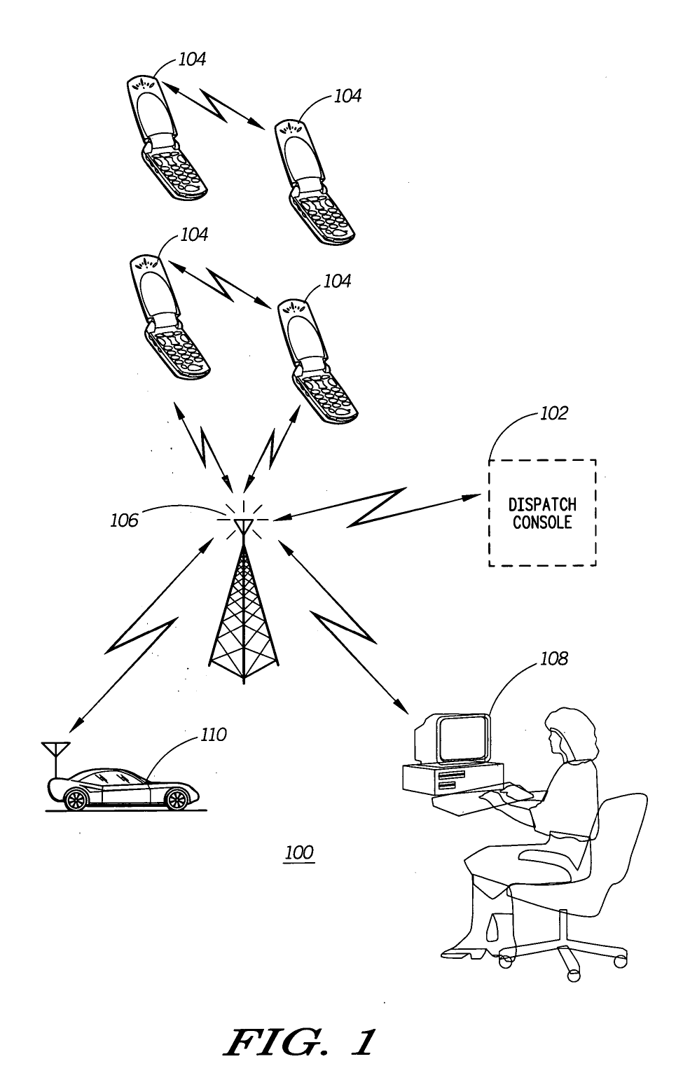

FIG. 1 is a block diagram of a communications system 100 operating in accordance with the present invention. Communications system 100 supports conventional or trunked operating systems and may further support cellular-based systems. Communications system 100 includes a dispatch console 102 communicating with a plurality of subscriber units 104 via base station 106. The dispatch console 102 may be stationary, as shown by stationary dispatch console 108, or mobile, as shown by mobile incident command console 110. Each subscriber unit 102 has dispatch capability, a unique unit identifier (ID) associated therewith, and user selectable channel capability. In accordance with the present invention, the dispatch console 102 automatically logs the unit ID of each subscriber unit that responds to an incident broadcast and forms a talkgroup of the logged unit IDs for future incident broadcasts. Each subscriber unit 104 can receive future incident broadcasts regardless of the channel selection. Subscriber users can thus switch channels or talkgroups without the fear of missing an incident broadcast. The subscriber units may be two-way radios or radios having both simplex and duplex capability, such as cellular capability and dispatch capability.

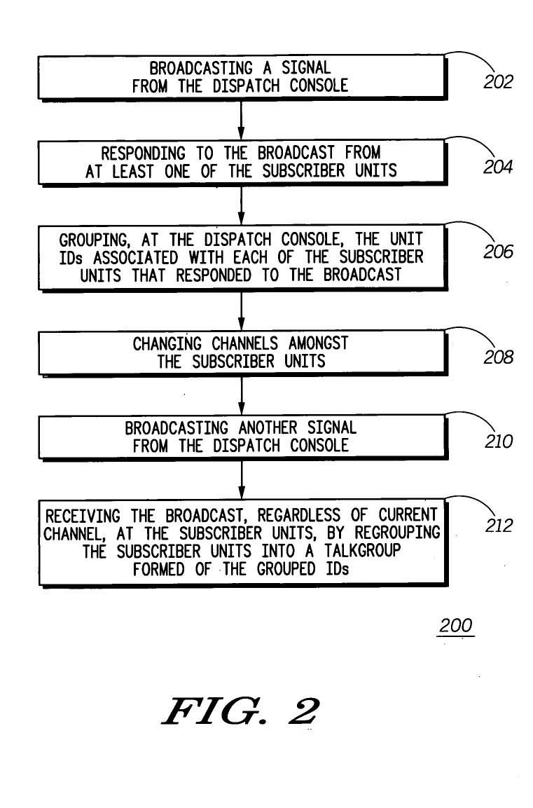

FIG. 2 is a method of broadcasting an incident alert in a communications system in accordance with the present invention. As with FIG. 1, the communications system includes a dispatch console and a plurality of subscriber units having unit IDs. The method 200 comprises the steps of broadcasting a signal from the dispatch console 202; responding to the broadcast from at least one of the subscriber units 204; and in accordance with the present invention, grouping, at the dispatch console, the unit IDs associated with each of the subscriber units that responded to the broadcast 206. In accordance with the present invention, the subscriber units may change channels 208 and still have the ability to receive another signal broadcast from the dispatch console 210, regardless of current channel by regrouping the subscriber units into a talkgroup formed of the grouped IDs 212. The plurality of subscriber units may comprise two-way radios or radios having both simplex and duplex capability, such as cellular capability as well as dispatch capability.

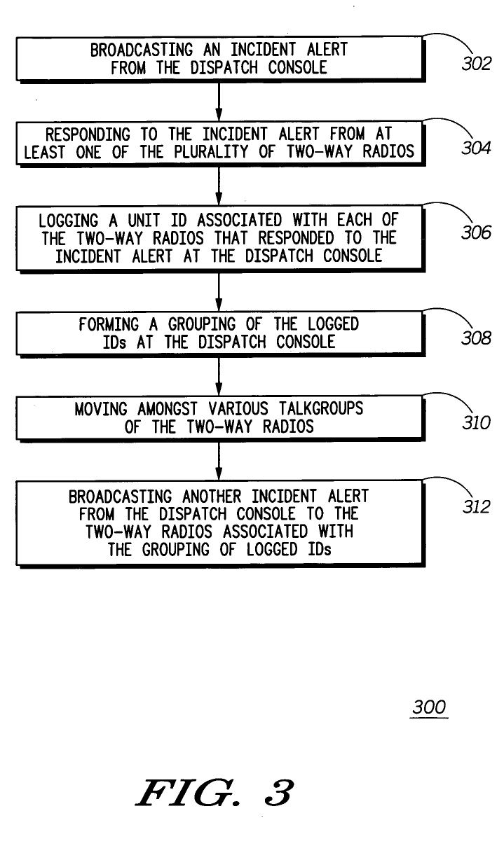

The ability to move amongst talkgroups or change channels without losing the ability to receive an incident broadcast is a significant benefit. FIG. 3 is an example of utilizing the method of broadcasting an incident alert described n FIG. 2 utilizing two-way radios. The steps include: broadcasting an incident alert from the dispatch console 302; responding to the incident alert from at least one of the plurality of two-way radios 304; and in accordance with the present invention, logging a unit ID associated with each of the two-way radios that responded to the incident alert at the dispatch console 306 and forming a grouping of the logged IDs at the dispatch console 308. Next, the two-way radios can move amongst various talkgroups 310 without fear of missing an incident alert, as the broadcasting of another incident alert from the dispatch console to the two-way radios is associated with the grouping of logged IDs 312. Thus, the grouping of radios does not miss the incident alert regardless of whether they have changed talkgroups.

The communication feature of the present invention allows a subscriber user to change talkgroups and/or channels without missing future broadcasts. The ability to regroup users is particularly useful in the public safety arena where police, fire, and rescue agencies as well as the armed forces need to maintain consistent communications. Businesses with dispatch requirements such as taxis, utilities, trucking, radio departments and so forth can likewise reap the benefits of the incident alert feature of the present invention.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A communication system, comprising:
a plurality of subscriber units, each subscriber unit having dispatch capability and a unit ID associated therewith; and
a dispatch console for communicating with the plurality of subscriber units, the dispatch console automatically logging the unit ID of each subscriber units that responds to an incident broadcast and forming a talkgroup of the logged unit IDs for future incident broadcasts.

2. The communication system of claim 1, wherein each subscriber unit includes
a channel selector and the future incident broadcasts are received regardless of the channel selector position.

3. The communication system of claim 1, wherein the subscriber units are two-way radios.

4. The communication system of claim 1, wherein the subscriber units have simplex and duplex capability.

5. The communication system of claim 4, wherein the subscriber units have cellular capability and dispatch capability.

6. The communication system of claim 1, wherein the dispatch console comprises at least one of a stationary dispatch console and a mobile incident command console.

7. A method of broadcasting an incident alert in a communications system having a dispatch console and a plurality of two-way radios, comprising:
broadcasting an incident alert from the dispatch console;
responding to the incident alert from at least one of the plurality of two-way radios;
logging a unit ID associated with each of the two-way radios that responded to the incident alert at the dispatch console;
forming a grouping of the logged IDs at the dispatch console;
moving amongst various talkgroups of the two-way radios; and
broadcasting another incident alert from the dispatch console to the two-way radios associated with the grouping of logged IDs.

8. A method of broadcasting an incident alert in a communications system having a dispatch console and a plurality of subscriber units having unit IDs, comprising:
broadcasting a signal from the dispatch console;
responding to the broadcast from at least one of the subscriber units;
grouping, at the dispatch console, the unit IDs associated with each of the subscriber units that responded to the broadcast;
changing channels amongst the subscriber units;
broadcasting another signal from the dispatch console; and
receiving the broadcast, regardless of current channel, at the subscriber units by regrouping the subscriber units into a talkgroup formed of the grouped IDs.

9. The method of claim 8, wherein the plurality of subscriber units comprise two-way radios.

10. The method of claim 8, wherein the plurality of subscriber units have both simplex and duplex capability.

11. The method of claim 8, wherein the subscriber units have cellular capability as well as dispatch capability.
